(19) United States
(12) Patent Application Publication
(10) Pub. No.: US 2010/0314838 A1
(43) Pub. Date: Dec. 16, 2010

(54) SEAL ASSEMBLY

(75) Inventor: Maurice William Slack, Edmonton (CA)

Correspondence Address: DONALD V. TOMKINS;C/O TOMKINS LAW OFFICE, 740, 10150 - 100 STREET, EDMONTON, AB, T5J 0P6, CA

(73) Assignee: NOETIC TECHNOLOGIES INC., Edmonton (CA)

(21) Appl. No.: 12/484,984

(22) Filed: Jun. 15, 2009

(51) Int. Cl. F16J 15/24

(52) U.S. Cl. 277/520

(57) ABSTRACT

A fluid seal assembly consists of a seal of compliant material that interacts with a seal carrier. The seal carrier includes one or more elements of relatively rigid material defining a sealing face with a seal-receiving groove interrupting the sealing face. The seal-receiving groove has defining walls each of which has a proximal end at the sealing face and a distal end. The defining walls serve as seal contact surfaces. At least one of the seal contact surfaces converges inwardly to narrow the seal-receiving groove toward the distal end. The seal-receiving groove has a depth and a breadth suitable for accepting the seal, with the seal projecting past the sealing face when compressed to be in contact with the seal contact surfaces.

### FIELD

This invention relates intentionally to applications where tools or devices must seal against surfaces with large tolerances and with surface finishes typical of as-rolled steel.

### BACKGROUND

An established method of configuring elastomeric seals, typical of O-ring type seals, to seal the gap between assembled first and second close fitting solid components, separated by an extrusion gap, is to provide a compliant yet largely incompressible elastomeric seal element in a generally rectangular seal groove of a controlled depth (defining the groove bottom surface) and width (defining the groove side wall surfaces) placed in the first component, referred to herein as the seal carrier, adjacent to a seal surface provided in the second component, referred to herein as the workpiece. The unconstrained seal element depth is selected to exceed the sum of the groove depth and gap so that interference is created between the seal element and the groove bottom and workpiece seal surfaces of the assembled components. This interference tends to deform the compliant elastomer by compression in a direction normal to the seal surface and, due to its generally incompressible bulk properties, expansion in the width direction. To accommodate the elongation in width the seal groove width is typically provided to slightly exceed the seal deformed element width to volumetrically accommodate this relatively incompressible elastomer deformation. This is typically desirable to avoid pressure entrapment in the cavities between the side wall and the seal element.

Configured thus, the seal element is forced into contact with the workpiece surface and groove bottom where, as is known to the art, the initiation of the seal function is dependent on arranging the design parameters of geometry, surface roughness, elastomer compliance and amount of interference to ensure initial contact stress distribution is sufficient to result in conformable contact between both the seal element and workpiece surface and seal element and seal groove bottom. However the effectiveness of this type of seal in some applications is limited, specifically where surface roughness of the work piece is high and cannot be readily controlled, and the extrusion gap tolerances are loose. In such applications, it can be difficult or impossible to arrange the available design parameters to both obtain the amount of interference required to achieve a reliable seal, within the allowable deformation limits of the available elastomeric materials with respect to material properties, and seal load constraints. Also the established method of installing an elastomer seal is to stretch the seal element over the seal carrier into the fixed geometry groove; this method of installation becomes increasingly difficult as the seal element thickness become large relative to the seal length. It is these needs that the present invention addresses.

### SUMMARY

There is provided a fluid seal assembly which consists of a seal of compliant material that interacts with a seal carrier. The seal carrier includes one or more elements of relatively rigid material defining a sealing face with a seal-receiving groove interrupting the sealing face. The seal-receiving groove has defining walls each of which has a proximal end at the sealing face and a distal end. The defining walls serve as seal contact surfaces. At least one of the seal contact surfaces converges inwardly to narrow the seal-receiving groove toward the distal end. The seal-receiving groove has a depth and a breadth suitable for accepting the seal, with the seal projecting past the sealing face when compressed to be in contact with the seal contact surfaces.

The above described fluid seal assembly provides an alternative to prior art seal assemblies. It will be understood that having the seal wedged into a converging seal-receiving groove can seal through an increased range of sealing gaps. When not confined by contact with a workpiece, the seal tends to move outwardly from the seal carrier to a neutral position. This simplifies the replacement of worn seals.

Although beneficial results may be obtained through the use of the fluid seal assembly, as described above, in some configurations the seal may tend to fall out of the seal carrier when not confined by contact with a workpiece and the seal moves to a neutral position. In such applications, it is preferred that the seal-receiving groove be narrowed at the sealing face by an inwardly projecting seal retainer at the proximal end of at least one of the seal contact surfaces. It will be understood that there are various retainer configurations which can utilized for this purpose.

In order to increase the pressure range through which this fluid seal assembly is operated, it is preferred that the depth of the seal-receiving groove exceed the maximum penetration of the seal to define an inner pressure chamber toward the distal end of the seal contact surfaces. A port can then be extended from the sealing face through the seal carrier to the inner pressure chamber. This enables fluid from the sealing face to communicate with the inner pressure chamber to pressurize the seal. In most applications, there will be a pressure differential on opposite sides of the seal. It will be understood that fluid from the area of higher pressure should be used to pressurize the seal.

As the thickness of a seal is increased it becomes more difficult to remove the seal by stretching. In such cases, it is preferred that a first seal contact surface be carried by a first element of the seal carrier and a second seal contact surface be carried by a second element of the seal carrier. This enables the first element and the second element to be separated to facilitate removal of the seal, where the thickness of the seal makes removal by stretching difficult.

As is known in the art, a seal that is perfectly circular in cross section can tend to roll under certain conditions of relative sliding between the work piece and seal carrier. An example of this tendency to roll is manifest in the well known torsional failure mode of axi-symmetric o-ring seals deployed to seal the annulus between a piston sliding in a bore. The toroidal shape of these seals does not resist rotation about the toroidal axis allowing segments of the seal to roll about the toroidal axis accumulating twist that can lead to premature failure. In applications where there is concern about the seal rolling it is preferred that the seal cross section be modified to resist rolling. Although the modified seal can remain generally circular in cross-section, it is preferred that the seal be provided with flat portions that generally correspond to the seal contact surfaces of the seal-receiving groove. The engagement under pressure of the flat portions of the seal with the flat seal contact surfaces will reduce rolling.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic section view of a seal assembly of the broadest aspect of the present invention, with a “V” shaped seal groove.

FIG. 2 is a schematic section view of a seal assembly of the present invention, with a single retention face.

FIG. 3 is a schematic section view of a seal assembly of the present invention, with a double faceted seal groove.

FIG. 4 is a schematic section view of the seal assembly of FIG. 3, shown as it would appear engaged with a workpiece with a large extrusion gap, and with a relative high pressure applied to the bottom end of the assembly.

FIG. 5 is a schematic section view of the seal assembly of FIG. 3, shown as it would appear engaged with a workpiece with a small extrusion gap.

FIG. 6 is a schematic section view of a seal assembly of the present invention, with high and low pressure fluid ports, shown as it would appear engaged with workpiece with a large extrusion gap, and with a relative high pressure applied to the bottom end of the assembly.

FIG. 7 is a section view of a tubular running tool with a seal assembly rigidly attached to the bottom end and shown as it would appear with the tubular running tool in the retracted position.

FIG. 8 is a section view of a seal assembly, shown as it would appear engaged in a tubular workpiece of large diameter.

FIG. 9 is a section view of the seal assembly of FIG. 8, shown as it would appear engaged in a tubular workpiece of small diameter.

FIG. 10 is a section view of half of the seal assembly of FIG. 8, shown as it would appear engaged in a workpiece of large diameter.

FIG. 11 is a section view of the seal assembly of FIG. 8, shown as it would appear partially disassembled to allow the seal element to be exchanged.

### DETAILED DESCRIPTION

### General Principals

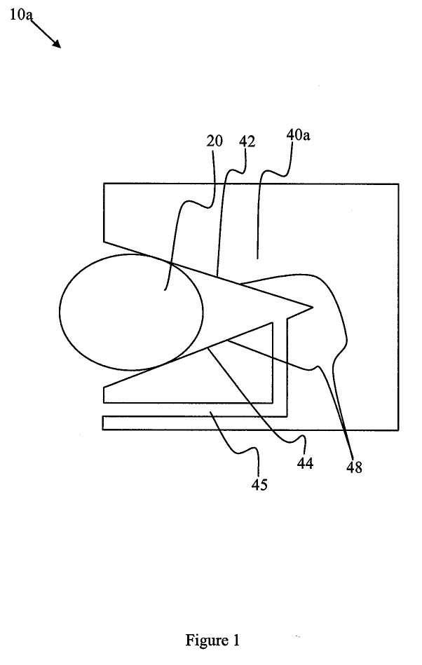

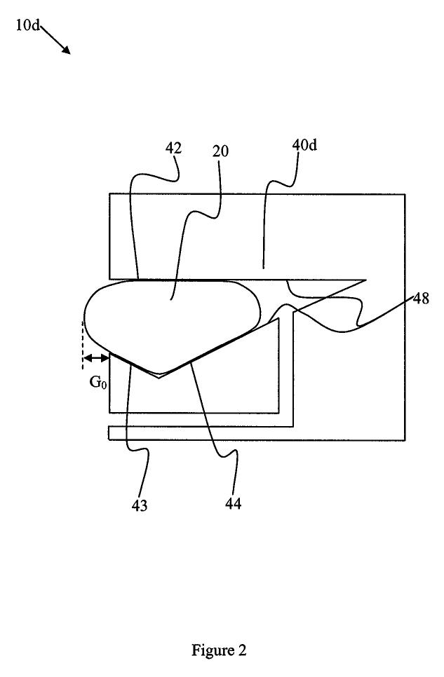

With reference to FIGS. 1 through 6 the general principals of the seal assembly of the present invention will now be described. FIG. 1 is a schematic cross section view of seal assembly 10a, shown as it would appear not engaged in a workpiece and defined by the broadest aspect of the present invention. Seal assembly 10a is comprised of seal carrier 40a and seal element 20. Seal carrier 40a has contact faces 42 and 44, generally arranged in a “V” shape, which collectively form clearance face pair 48. The length and angles of faces 42 and 44 of clearance face pair 48 are selected in conjunction with the size and shape of seal element 20 to allow for inward or retract movement of seal element 20, and also to return seal element to the neutral position when unloaded. It is understood that depending on the path of the seal groove, the seal groove geometry of seal assembly 10a may allow the seal element 20 to come out of the seal groove completely when unloaded, and as such some retention method is required. This retention method can be hoop stress in the seal element in cases where the seal carrier and workpiece are generally axi-symmetric in shape. However, it may be desirable to have additional seal retention means, to this end, further aspects of the present invention are described, with reference to FIGS. 2 through 6. Referring now to FIG. 2, a schematic cross section view of seal assembly 10d shown as it would appear not engaged in a workpiece, seal carrier 40d of seal assembly 10d has a seal groove defined by a single retention face 43 and a clearance face pair 48 comprised of clearance faces 42 and 44 where the angles of the clearance faces are not equal and clearance face 42 is arranged, in this embodiment, such that it is normal to the seal surface of the workpiece (not shown). This embodiment of the present invention provides seal retention regardless of seal groove path shape.

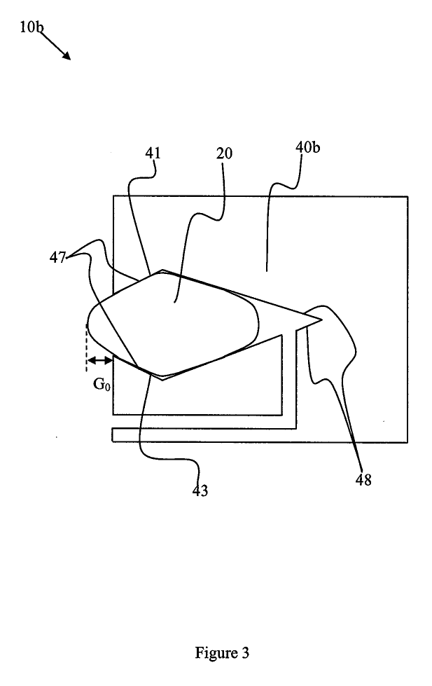

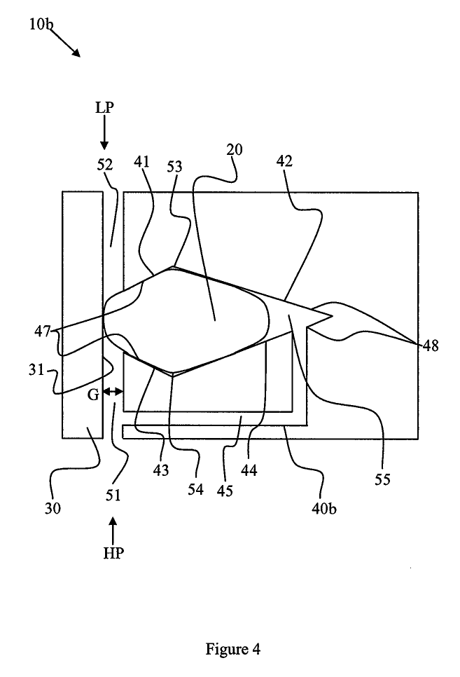

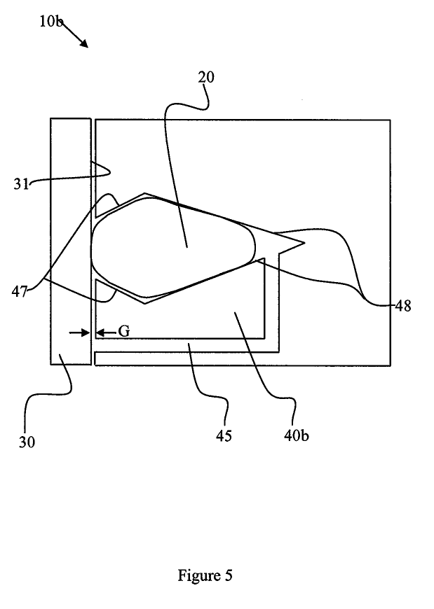

Referring now to FIG. 3, which is a schematic cross section view of an alternative embodiment of seal assembly 10b shown as it would appear not installed in a workpiece, seal assembly 10b is comprised of seal element 20 and seal carrier 40b, having a seal groove defined by two retention faces 41 and 43. Referring now to FIG. 4 showing seal assembly 10b installed in workpiece 30 with a large extrusion gap width indicated by “G”, seal carrier 40b has contact faces 41, 42, 43 and 44, where contact faces 41 and 43 collectively form retention face pair 47 and contact faces 42 and 44 collectively form clearance face pair 48. The length and angle of faces 41 and 43 of retention face pair 47 are selected in conjunction with the size and shape of the seal element 20 to prevent loss of containment of the seal element 20 during engagement and disengagement from the workpiece 30, as well retention face pair 47 functions to position the seal in the neutral position to ensure engagement with the workpiece 30 over a range of gap widths “G”. Referring again to FIG. 3, seal element 20 is shown in the neutral position, and the maximum gap width at which initial seal engagement will occur is indicated by “G₀”. Referring now to FIG. 4, gap “G” is reduced providing seal interference with the workpiece 30 as required to initiate a seal under pressure. Referring now to FIG. 5, seal assembly 10b is shown as it would appear engaged in a workpiece 30, with a yet smaller extrusion gap “G”, causing seal element 20 to retract further and come out of contact with both the retention face pair 47 and increase contact with clearance face pair 48. Referring again to FIG. 4, the length and angle of faces 42 and 44 of clearance face pair 48 are selected in conjunction with the size and shape of seal element 20 to allow for inward or retract movement of seal element 20 in a direction normal to face 31 of workpiece 30, to accommodate the required range of gap widths “G”. Also the angles of clearance face pair 48 are selected with consideration of frictional forces to ensure seal element 20 tends to return to its neutral position from the retracted position upon unloading, to prevent “sticking” in the retracted position.

It will now be generally apparent that the present invention provides a means to increase the amount of interference allowable with a given seal cross section enabling the seal to function over a larger range of gap widths “G” than would otherwise be possible with a similar cross section seal retained in a conventional, generally rectangular, groove geometry. It will now further be apparent that this is accomplished because the amount of distortional strain generated by a given incremental reduction in gap, or increase in interference, is reduced. Referring still to FIG. 4, seal element 20, in this embodiment has a circular cross-section and is shown approximately as it would appear compressed and contacting workpiece 30 on inside surface 31 and seal carrier 40b on contact faces 41, 42, 43 and 44, however, it is understood that the seal element of the present invention is not limited to this cross section and that other shapes may be used to increase some desirable properties. Seal shapes can be selected with geometry features that provide any or all of the following improvements in functionality over a base geometry circular cross section seal element: (1) resistance to rotation and twisting during insertion by providing a large flat contact face that engages one or both faces of clearance face pair, (2) reduced radial load during insertion by providing a smaller contact patch between seal element and clearance face pair, and (3) increased or decreased initial contact pressure by modifying contact radii and/or providing a flat contact interface between the seal element and the workpiece or seal carrier. With reference to FIGS. 3 through 5 retention face pair 47 and clearance face pair 48 of seal assembly 10b are shown to be symmetrical top to bottom, however it is understood that either or both of the retention face pair 47 and the clearance face pair 48 can be selected to be non-symmetrical as may be desirable in some cases, and as such movement of seal element 20 in not limited to a direction normal to contact face 31 of workpiece 30 (not shown in FIG. 3).

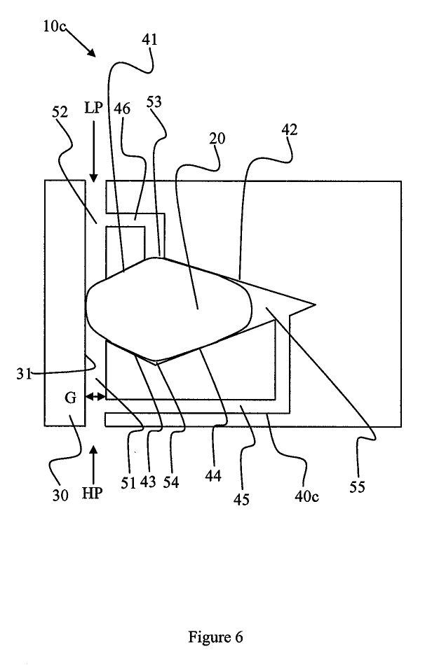

Referring again to FIG. 4, seal element 20 is made of a sufficiently compliant material such that it comes into substantially conformable contact, creating five chambers 51, 52, 53, 54 and 55. High pressure fluid port 45 connects chamber 51 and 55 and it is understood that chamber 54, while not directly linked to a high pressure source, can generally be assumed to be at high pressure due to surrounding regions of high pressure. It is understood that there is some remaining ambiguity regarding whether seal element 20 will sealingly engage seal carrier 40b on face 41 or face 42. To this end a further aspect of the present invention is described with reference to FIG. 6, to address this ambiguity low pressure fluid port 46 can be included in seal carrier 40c of seal assembly 10c, whereby port 46 connects chambers 52 and 53 ensuring that chambers 52 and 53 are linked to the relative low pressure side of seal element 20. Conformable contact can remain between seal element 20 and all five contact faces 31, 41, 42, 43 and 44 on the workpiece 30 and seal carrier 40c, as geometry allows, while only faces 31 and 42 retain sealing engagement with seal element 20.

### Tubular Running Tool Seal Assembly

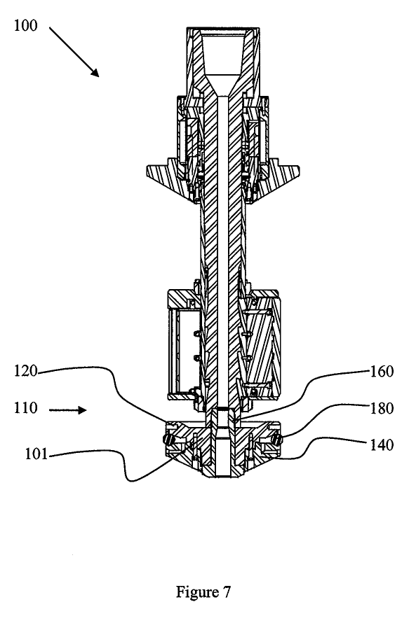

With reference to FIGS. 7 through 11, there will now be described a preferred embodiment of the seal assembly of the present invention. Referring now to FIG. 7, showing cross section view of a tubular running tool 100 with seal assembly 110 at lower end 101, seal assembly 110 is comprised of upper seal retainer 120, lower seal retainer 140, seal assembly retention element 160 and seal element 180, and is shown as it would appear with tubular running tool 100 in the retracted position. In this case seal element 180 is shown with a circular cross section, where the edge of said seal element overlaps the edge of both the upper and lower seal retainers 120 and 140 respectively, it is understood that this is for the purpose of illustrating interference between these components only and that the assembled seal element 180 will be partially compressed by the upper and lower seal retainers and as such where interference is illustrated in this view the seal element 180 will come into partial conformable contact with both upper and lower seal retainers 120 and 140 respectively and sealingly engage upper seal retainer 120.

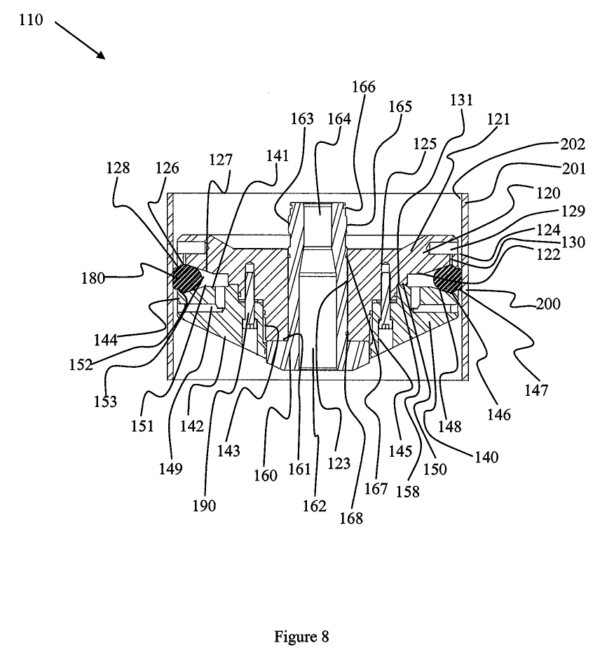

Referring now to FIG. 8, showing a cross section view of seal assembly 110 as it would appear coaxially located, internal to and sealingly engaged with workpiece 200, the diameter of the internal surface 202 of workpiece 200 is at the large end of a specified allowable range for seal assembly 110. Upper seal retainer 120 has upper face 121, lower face 122, inner face 123 and outer face 124. Lower face 122 of upper seal retainer 120 has a plurality of threaded bolt holes 125 disposed around the circumference near the mid-radius of the part, downward facing shoulder 131 and a double faceted half seal grove 126, comprised of retention face 127 and clearance face 128, near outer face 124. Upper seal retainer 120 also has a plurality of radially oriented pin holes 129 disposed on outer face 124 and connected to lower face 122 by relief ports 130 which intercept the half seal groove 126 at the convergence point of the retention face 127 and clearance face 128. Lower seal retainer 140 has upper face 141, lower face 142, inner face 143, outer face 144, and a plurality of countersunk bolt holes 145 extending between lower face 142 and upper face 141. Upper face 141 of lower seal retainer has a double faceted half seal groove 146, comprised of retention face 147 and clearance face 148, near outer face 144, and upward facing shoulder 158. Upward facing shoulder 158 of lower seal retainer 140 and downward facing shoulder 131 of upper seal retainer 120 collectively form shoulder pair 150. The lower face 142 of lower seal retainer 140 is in this case configured as a stabbing guide, generally frusto-conical in shape, and selected to be so to centralize a casing running tool (not shown in the view) during insertion into proximal end 201 of workpiece 200. Upper and lower seal retainers 120 and 140 respectively are arranged such that they are rigidly attached to one another, in this case by a plurality of cap screws 190 (in this case ten, two shown in this view) threaded into holes 125 of upper seal retainer 120 with heads shouldering in counter-bored holes 145 of lower seal retainer 140, tension in cap screws 190 is reacted through shoulder pair 150 providing a fixed geometry for seal groove 153. Seal element 180 is located between upper and lower seal retainers 120 and 140 respectively in seal groove 153, and is in this embodiment of the present invention toroidal in shape i.e., axi-symmetric with a circular cross-section. Although, shown in this view in a compressed state the seal element 180, made from a sufficiently flexible and compliant material, substantially conforms to the shape of seal groove 153 and is radially confined by inside surface 202 of workpiece 200. The seal groove 153 is defined by clearance face pair 151 and retention face pair 152, where the relative angles of clearance face 128 and 148 are selected to provide both compliant retraction and resistance to “sticking” of seal element 180, where “sticking” is defined as the tendency of the seal element 180 to remain in the radially inward retracted position upon removal of assembly 110 from workpiece 200. The relative angles of retention faces 127 and 147 are selected to prevent loss of containment of seal element 180, defined as the tendency of seal element to come out of seal groove 153 during insertion into and extraction from workpiece 200. The retention face pair 152 is also selected so that when not under pressure, they locate the seal in the neutral position. The radial position of the maximum height of seal groove 153 can be chosen in conjunction with the diameter of seal element 180 to provide a pre-stress hoop compression or expansion of seal element 180 to bias it in favour of contact or retraction, as well as to locate seal element 180.

Referring still to FIG. 8, assembly retainer 160, located internal to and coaxially with upper seal retainer 120 is provided separate from upper seal retainer 120, and has upward facing shoulder 161 at lower end 162 and thread element 163 at upper end 164. It is understood that the assembly retainer 160 can be made to be integral to upper seal retainer 120 and is separate in this embodiment of the present invention due to material strength and availability requirements. Disposed along the outer surface 165 of assembly retainer 160 are grooves containing seal elements 166, 167 and 168. Assembly retainer 160 is arranged such that seal elements 167 and 168 sealingly engage inner face 123 of upper seal retainer 120, while seal element 166 and thread element 163 collectively sealingly and threadingly engage the lower end 101 of tubular running tool 100 (not shown in this view). In this embodiment of the present invention seal element 180 has a circular cross section, it is understood that the seal assembly of the present invention is not limited to a seal element with this cross sectional profile, and that any profile shape which provides both a contact interface with the inside surface of the workpiece 200 for a range of gap widths, a sufficiently small exposed contact angle relative to the axis of the tool to facilitate seal element 180 retraction when installing in workpiece 200, and provides contact interfaces with the retention and clearance faces of the upper and lower seal retainers 120 and 140 respectively.

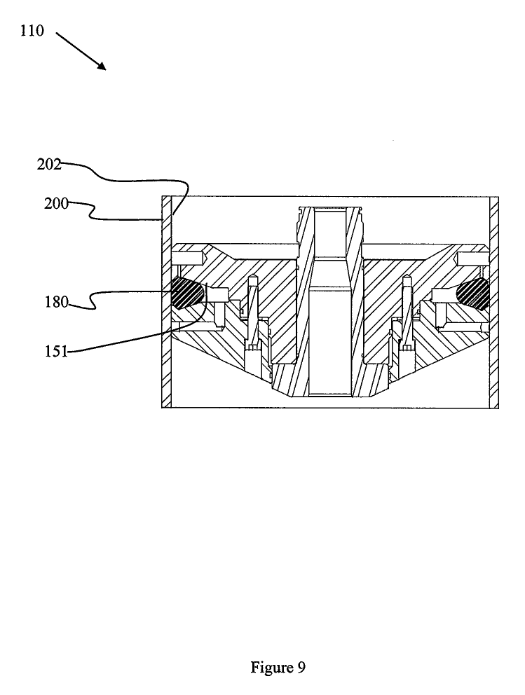

Referring now to FIG. 9, showing seal assembly 110 in a cross section view as it would appear coaxially located and sealingly engaged with a workpiece 200 with an inside diameter at the small end of the allowable range. Seal element 180 in conjunction with the clearance face pair 151 allows for radial inward retraction of seal element 180 when the inside surface 202 of workpiece 200 has a diameter at the small end of the allowable range. It is understood that seal element 180 has a circular cross section, shown is this view approximately as it is expected to appear compressed between seal retainers 120 and 140 and workpiece 200. Referring again to FIG. 8, lower seal retainer 140 is provided with a plurality of fluid ports 149 which allow movement of fluid between the outer surface 144 and the upper surface 141 of lower seal retainer 140, and to seal groove 153 internal to seal element 180, thus providing pressure acting on the inside of seal element 180 as a further means to engage seal element 180 on inside surface 202 of workpiece 200. Seal groove 153 and fluid ports 149 may be filled with a grease or other substance with relatively high viscosity throughout the range of the tools operating temperature in order to maintain relatively free exchange of pressure through ports 149 that might otherwise be plugged with drilling mud or other solids containing fluids, preventing pressure exchange and proper function of seal assembly 110.

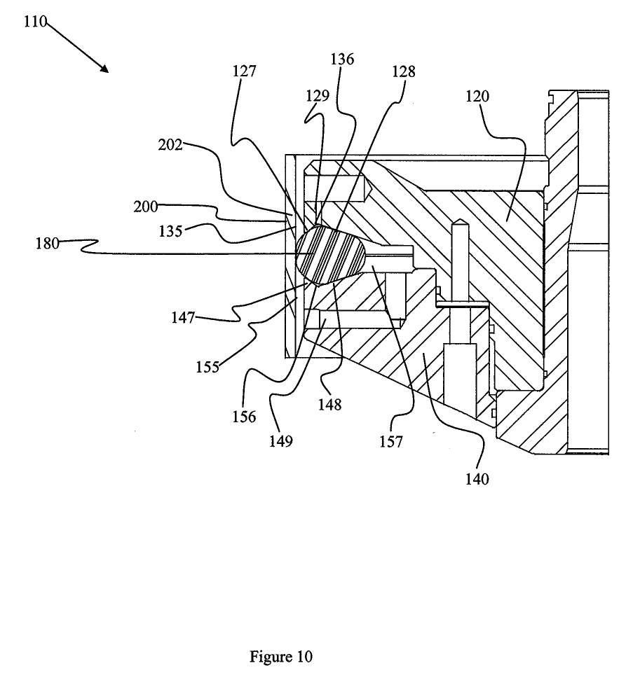

The specific function of seal assembly 110 will be described in reference to FIG. 10, showing a partial section view of seal assembly 110 engaged in workpiece 200. While it is shown in this view that seal element 180 contacts and engages upper and lower seal retainers in four locations on faces 127, 128, 147, and 148, and also engages the inside surface 202 of workpiece 200, it is understood that if the diameter of inside surface 202 workpiece 200 is small that resultant radial movement of seal element 180 may result in loss of seal engagement on surfaces 127 and 147, and as such seal element 180 will engage only on faces 128 and 148, also as a result of this potentially intermittent contact debris from the inside surface 202 of the workpiece 200 can collect on surfaces 127 and 147 such that upon subsequent engagement sealability on said faces may be compromised. It is understood that the high pressure side of the seal is ported by fluid ports 149 to include chambers 155, 156, and 157, while the low pressure side of the seal is ported by fluid ports 129 to include chambers 135 and 136, consequently, sealing engagement occurs on surfaces 128 and 202.

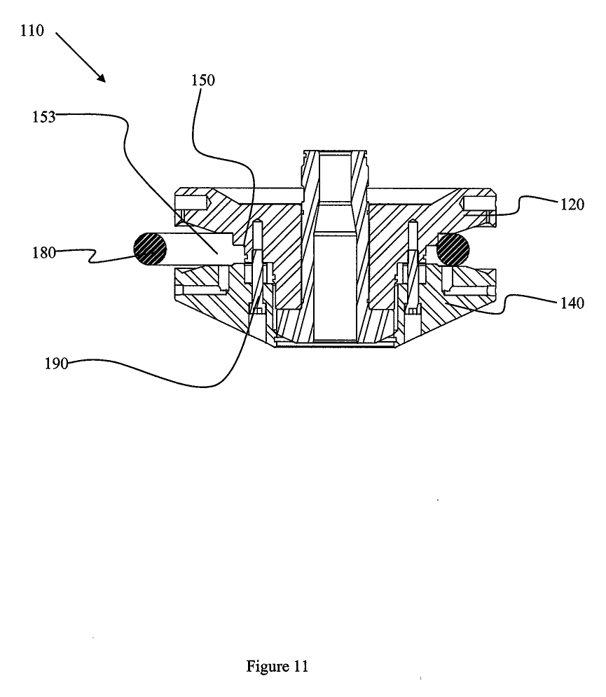

Referring now to FIG. 11 which shows the seal assembly 110 as it would appear partially disassembled to allow removal of seal element 180 and installation of a new seal element 180. In this configuration the cap screws 190 of seal assembly 110 have been partially removed allowing additional separation between upper and lower seal retainers 120 and 140 respectively, in this position seal element 180 can be moved laterally in the seal groove 153 such that one side is located adjacent to the load shoulder pair 150 close to the mid-radius of the seal assembly, while the opposite end of seal element 180 is radially external to seal assembly 110 and can be removed provided seal element is of sufficiently low minor diameter and is fabricated from a sufficiently strong, flexible and compliant material typical of elastomers used for fluid seals.

In summary the seal assembly described above is comprised of a seal carrier having a groove defined by two side walls carrying an elastomer seal element arranged when assembled adjacent to the seal surface of a workpiece to seal the gap between the seal carrier and the workpiece,
where one or both of the two side walls over an interval of increasing depth, (referred to herein as clearance faces and collectively as a clearance pair) is tapered, and arranged so that the groove width or groove taper decreases with depth, and
where the elastomeric seal element is configured to be close fitting with the clearance faces the angles of the two side walls relative to the seal surface of the workpiece are selected to allow the seal element to move normal to the seal surface while being compressed laterally between the clearance faces,
and when assembled with the workpiece to seal the gap by creating interference with the space defined by the workpiece seal surface and the clearance faces.

The groove taper is selected with consideration to the friction forces present in a given application such that when the seal is disengaged from the workpiece the seal element moves outwards to its neutral position. Depending on the shape of the seal, the seal groove geometry as described may allow the seal element to come out of the seal groove completely, and as such a retention method is desirable. In the case where the seal groove and workpiece are circular or cylindrical the retention may be accomplished using the hoop stiffness of the seal element. However for applications where this means of retention is not adequate or available, as for example in face seal applications, one or both of the side walls of the seal groove may be provided with a seal retainer in the form of a second tapered face, referred to herein as retention faces, or collectively as the retention face pair. As such the groove geometry is selected so that the width of the groove is smaller near the outside surface of the seal carrier, where the outermost face of the seal groove is the retention face, which tapers away from the retention face on the opposite groove side wall, to a point of maximum width where the retention face intersects the inside facet of the seal groove sidewall, defined previously as the clearance face. The intersection point of the faces of the seal groove sidewalls defines the neutral position of the seal element, where the seal element will be positioned when not under pressure or engaged on a workpiece. The neutral position is selected in conjunction with the seal element geometry to position the seal element to engage the workpiece and provide some initial contact engagement over the range of workpiece/seal carrier gap widths. The angle of the retention face pair relative to the seal surface of the workpiece is selected to position the seal element in the neutral position when not loaded and to prevent loss of seal containment by minimizing the seal groove opening width.

The seal assembly of the present invention is uni-directional, while the groove geometry can be symmetrical; the assembly is arranged such that the groove internal to the seal element is ported to the high pressure side of the seal. As such, the seal element of the present invention sealingly engages the seal surface of the workpiece and the clearance face on the low pressure side of the seal.

It is generally understood that the interference limit for elastomers is approximately 30%, before premature material breakdown can occur, where interference is defined by the relative percentage of the seal cross sectional thickness when engaged on a seal surface as compared to the unconstrained seal cross sectional thickness. It will be apparent to one skilled in the art that seal assemblies with a reduced the interference to interference displacement ratio, will allow an increase in the range of sealable gap widths, where interference displacement is defined as the difference between the unconstrained elastomer seal located in the seal carrier and the seal surface of the workpiece, basically the magnitude that the gap size can be increased before the elastomer to seal surface contact is lost, it is this fact combined with the reduced engagement load that provides utility to the present invention.

An advantage provided by the present invention is the ability to easily change seal elements, as may be necessary, due to wear or damage. Typically elastomer seals are installed by stretching the seal element over the seal carrier into a fixed geometry groove. This becomes increasingly difficult as the seal element thickness increases relative to the seal length which is typical of seal elements of the present invention. To address this the seal carrier is selected to be made of and upper and lower part such that the parts can be partially disassembled and the depth of the seal groove selected so that the seal element can be moved laterally and removed from the seal carrier without requiring the seal element to be stretched.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A fluid seal assembly, comprising:
a seal of compliant material;
a seal carrier comprised of one or more elements of relatively rigid material defining a sealing face with a seal-receiving groove interrupting the sealing face, the seal-receiving groove having defining walls each of which has a proximal end at the sealing face and a distal end, the defining walls serving as seal contact surfaces, at least one of the seal contact surfaces converging inwardly to narrow the seal-receiving groove toward the distal end, the seal-receiving groove having a depth and a breadth suitable for accepting the seal with the seal projecting past the sealing face when compressed to be in contact with the seal contact surfaces.

2. The fluid seal assembly of claim 1, wherein the seal-receiving groove is narrowed at the sealing face by an inwardly projecting seal retainer at the proximal end of at least one of the seal contact surfaces.

3. The fluid seal assembly of claim 1, wherein the seal has a generally circular cross-section.

4. The fluid seal assembly of claim 3, wherein the generally circular cross-section of the seal has flat portions that generally correspond to the seal contact surfaces of the seal-receiving groove.

5. The fluid seal assembly of claim 1, wherein the seal is axi-symmetric with an inner circumferential surface, an outer circumferential surface and a generally circular cross-section.

6. The fluid seal assembly of claim 5, wherein the generally circular cross-section of the axi-symmetric seal has flat portions, generally corresponding to the seal contact faces of the seal-receiving groove, at least one of the flat portions converging from the outer circumference toward the inner circumference.

7. The fluid seal assembly of claim 1, wherein the depth of the seal-receiving groove exceeds the maximum penetration of the seal to define an inner pressure chamber toward the distal end of the seal contact surfaces, a port extending from the sealing face through the seal carrier to the inner pressure chamber, whereby fluid from the sealing face communicates with the inner pressure chamber.

8. The fluid seal assembly of claim 1, wherein a first seal contact surface is carried by a first element of the seal carrier and a second seal contact surface is carried by a second element of the seal carrier.

9. The fluid seal assembly of claim 1, wherein the seal is an elastomer seal.

10. A fluid seal assembly, comprising:
a workpiece having a target seal surface
a seal of compliant material; and
a seal carrier assembly comprised of one or more elements of relatively rigid materials having a sealing face shaped to be close fitting with the target seal surface of the workpiece and a seal-receiving groove interrupting the sealing face, the seal-receiving groove being defined by a first seal contact surface and a second seal contact surface, the first seal contact surface and the second seal contact surface having a proximal section and a distal section, the distal section of the first contact surface and the second contact surface converge to narrow the seal-receiving groove distally, the seal-receiving groove having a depth and a breadth suitable for accepting the seal with the seal projecting past the sealing face when compressed to be in contact with the first seal contact surface and the second seal contact surface.

11. The fluid seal assembly of claim 10, wherein the seal-receiving groove is narrowed at the sealing face by an inwardly projecting seal retainer at the proximal end of at least one of the seal contact surfaces.

12. The fluid seal assembly of claim 10, wherein the seal has a generally circular cross-section.

13. The fluid seal assembly of claim 12, wherein the generally circular cross-section of the seal has flat portions that generally correspond to the seal contact surfaces of the seal-receiving groove.

14. The fluid seal assembly of claim 10, wherein the seal is axi-symmetric with an inner circumferential surface, an outer circumferential surface and a generally circular cross-section.

15. The fluid seal assembly of claim 14, wherein the generally circular cross-section of the axi-symmetric seal has flat portions the generally corresponding to the seal contact faces of the seal-receiving groove, at least one of the flat portions converging from the outer circumference toward the inner circumference.

16. The fluid seal assembly of claim 10, wherein the depth of the seal-receiving groove exceeds the maximum penetration of the seal to define an inner pressure chamber toward the distal end of the seal contact surfaces, a port extending from the sealing face through the seal carrier to the inner pressure chamber, whereby fluid from the sealing face communicates with the inner pressure chamber.

17. The fluid seal assembly of claim 10, wherein a first seal contact surface is carried by a first element of the seal carrier and a second seal contact surface is carried by a second element of the seal carrier.

18. The fluid seal assembly of claim 10, wherein the seal is an elastomer seal.

19. A fluid seal assembly, comprising:
a workpiece having a target seal surface
a compliant elastomer seal; and
a seal carrier assembly comprised of more that one element of relatively rigid materials having a sealing face shaped to be close fitting with the target seal surface of the workpiece and a seal-receiving groove interrupting the sealing face, the seal-receiving groove being defined by a first seal contact surface carried by a first of the elements and a second seal contact surface carried by a second of the elements, the first seal contact surface and the second seal contact surface having a proximal section and a distal section, the distal section of the first contact surface and the second contact surface converge to narrow the seal-receiving groove distally, the seal-receiving groove having a depth and a breadth suitable for accepting the seal with the seal projecting past the sealing face when compressed to be in contact with the first seal contact surface and the second seal contact surface;
the depth of the seal-receiving groove exceeding the maximum penetration of the seal to define an inner pressure chamber toward the distal end of the seal contact surfaces, a port extending from the sealing face through the seal carrier to the inner pressure chamber, whereby fluid from the sealing face communicates with the inner pressure chamber.
